(19) United States
(12) Patent Application Publication
(10) Pub. No.: US 2009/0276552 A1
(43) Pub. Date: Nov. 5, 2009

(54) MOTHERBOARD AND POWER MANAGING METHOD FOR GRAPHIC CARD INSTALLED THEREON

(75) Inventors: Chao-Chung Wu, Taipei (TW); Yu-Chen Lee, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/426,300

(22) Filed: Apr. 20, 2009

(30) Foreign Application Priority Data
Apr. 30, 2008 (TW) 97115895

(51) Int. Cl. G06F 13/00

(52) U.S. Cl. 710/104

(57) ABSTRACT

A motherboard and a power managing method for a graphic card installed thereon are provided. When the motherboard is switched to a second performance mode from a first performance mode, a microcontroller in the motherboard outputs a regulation signal to the graphic card through an exclusive connection interface, so as to correspondingly adjust an operation parameter of the graphic card, thus achieving better overall power saving and performance improving the effects of a computer.

### CROSS-REFERENCE TO RELATED APPLICATION

This application claims the priority benefit of Taiwan application serial no. 97115895, filed on Apr. 30, 2008. The entirety of the above-mentioned patent application is hereby incorporated by reference herein and made a part of specification.

### BACKGROUND OF THE INVENTION

1. Field of the Invention

The present invention generally relates to a motherboard, in particular, to a motherboard and power management interface, capable of managing the motherboard and graphic card power efficiency at the same time.

2. Description of Related Art

The concept of power saving is popular due to global warming, therefore, people pay more attention to power saving concept-related designs in computer-related devices, and the motherboard manufacturers begin to add the designs having the power saving concept into the motherboard. For the recent motherboard, a dynamic power saving technology is used to reduce the power consumption. In the dynamic power saving technology, a multi-segment power loop design is mainly used, such that the power module may provide different powers to the motherboard according to different loads and electrical demands, thereby reducing the power consumption of the motherboard and increasing the electrical efficiency of the motherboard.

Recently, operation frequencies and operation voltages of the motherboard and the graphic card are separately set, so the user may respectively adjust the operation parameters of the motherboard and the graphic card as desired, so as to achieve the power saving. However, the graphic card may not self-adjust the corresponding operation parameter according to an operation mode of the motherboard, and thus for the overall computer power management, no matter for the performance improving or the power saving effect, the convenience and the electrical adjusting coordination are still waiting to be enhanced.

In addition, the operation voltages and the frequencies of the motherboard and the graphic card are not certainly the same, so in the conventional art, when the motherboard performs the dynamic power saving, the graphic card may not self-adjust to an appropriate operation mode, thus resulting in electrical efficiency gap to cause a poor overall computer power saving effect.

### SUMMARY OF THE INVENTION

Accordingly, the present invention is directed to a motherboard, on which a graphic card is installed. The motherboard includes a first connection interface and a microcontroller. The first connection interface is connected to a graphic card, and the microcontroller is connected to the graphic card through a second connection interface. When the motherboard is switched to a second performance mode from a first performance mode, the microcontroller outputs a regulation signal to the graphic card through the second connection interface, so as to correspondingly adjust an operation parameter of the graphic card.

The present invention is further directed to a power managing method for a graphic card, which includes the following steps. First, it is determined whether or not a motherboard is switched to a second performance mode from a first performance mode. When the motherboard is switched to the second performance mode from the first performance mode, a regulation signal is output to the graphic card through a general purpose I/O (GPIO) interface, so as to correspondingly adjust an operation parameter of the graphic card.

In the present invention, an exclusive connection interface is disposed between the motherboard and the graphic card, so the motherboard may dynamically adjust the operation parameter of the graphic card through the connection interface, such that the graphic card matches with an operation mode of the motherboard, thereby achieving the optimal power management benefit and performance.

In order to have a further understanding of above features and efficacies of the present invention, a detailed description is given below with embodiments and accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a motherboard according to a first embodiment of the present invention.

FIG. 2 is a block diagram of a motherboard according to a second embodiment of the present invention.

FIG. 3 is a flow chart of a power managing method for a display according to a third embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

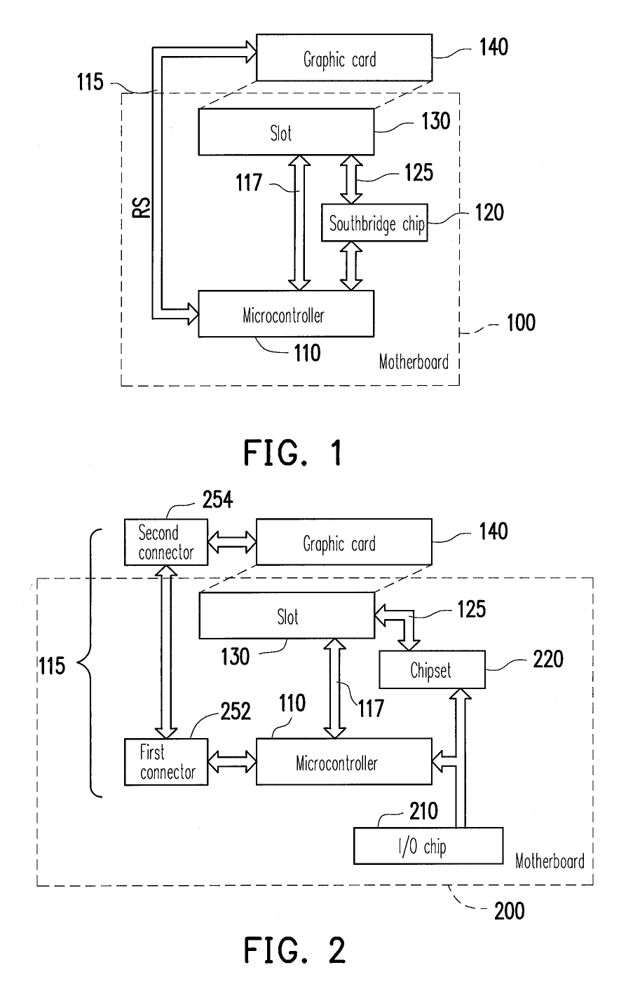

Referring to FIG. 1, a block diagram of a motherboard according to a first embodiment of the present invention is shown. A motherboard 100 includes a first connection interface (including a slot 130 and a bus 117), a microcontroller 110, and a Southbridge chip 120. A graphic card 140 is installed on the motherboard 100 through the slot 130 of the first connection interface. The first connection interface is, for example, a peripheral component interconnect (PCI) interface or a PCI Express (PCIe) interface, so the slot 130 is, for example, a PCI slot or a PCIe slot, and the specification used by the bus 117 is, for example, a PCI interface or a PCIe interface. The Southbridge chip 120 is connected to the graphic card 140 through the bus (for example, a system management bus (SMBus)) 125. The microcontroller 110 is connected to the graphic card 140 through the second connection interface 115, and the second connection interface 115 is, for example, a general purpose I/O (GPIO) interface.

When the motherboard 100 performs the performance mode switch, for example, when the motherboard 100 is switched to a low performance mode from a high performance mode, or to the high performance mode from the low performance mode, the microcontroller 110 outputs a regulation signal RS to the graphic card 140 through the second connection interface 115, so as to correspondingly adjust an operation parameter (for example, an operation voltage or an operation frequency) of the graphic card 140, thus obtaining a better operation performance. Generally, in the high performance mode, the operation voltage or the operation frequency of the motherboard 100 are higher, and in the low performance mode, the operation voltage or the operation frequency of the motherboard 100 are lower. The higher operation voltage and operation frequency of the motherboard 100 may result in the higher power consumption, but achieve better performance of the computer.

When the motherboard 100 is switched to the low performance mode from the high performance mode, the operation voltage, the operation frequency, and other parameters are lowered to reduce the power consumption, and the microcontroller 110 outputs a regulation signal RS to the graphic card 140 through the second connection interface 115, so as to correspondingly adjust the operation parameter of the graphic card 140. The operation voltage, the operation frequency, and other parameters of the graphic card 140 are correspondingly lowered according to the regulation signal RS, so as to increase the power saving effect. On the contrary, when the motherboard 100 performs the performance improvement (is switched to the high performance mode from the low performance mode); the operation voltage, the operation frequency, and other parameters are raised to increase the computer performance. Here, the microcontroller 110 similarly outputs a regulation signal RS to the graphic card 140 through the second connection interface 115, so as to correspondingly adjust the operation parameter of the graphic card 140. Then, the operation voltage, the operation frequency, and other parameters of the graphic card 140 are correspondingly raised according to the regulation signal RS, so as to increase the computer performance.

In addition, the microcontroller 110 may also adjust the operation parameter of the graphic card 140 through the Southbridge chip 120. Particularly, when the GPIO pin number supported by the microcontroller 110 is insufficient, the microcontroller 110 may transmit the regulation signal RS to the graphic card 140 through the GPIO and the SMBus at the same time, so as to correspondingly adjust the operation parameter of the graphic card 140. It should be noted that recently certain motherboard manufacturers may integrate the Southbridge chip with the Northbridge chip to form a single chipset, so although in this embodiment the Southbridge chip 120 is set as an example, the present invention is not limited to this embodiment, and a chipset may also be used. In addition, in this embodiment, a button (not shown) may also be disposed, the button is connected to the microcontroller 110 and enables the microcontroller 110 to output the regulation signal RS to the graphic card 140, so as to correspondingly adjust the operation parameter of the graphic card 140. That is to say, the user may set the operation parameter of the graphic card through hardware or application programs.

To sum up, in this embodiment, when the motherboard 100 adjusts the operation voltage, the operation frequency, and other parameters to adjust the computer performance, the microcontroller 110 may adjust the parameter of the graphic card 140 through the exclusive connection interface, thus achieving better power saving effect and performance improving effects.

### Second Embodiment

FIG. 2 is a block diagram of a motherboard according to a second embodiment of the present invention. The difference between FIGS. 2 and 1 mainly lies in an I/O chip 210, a first connector 252, and a second connector 254. The I/O chip 210, as a super I/O, is mainly used to perform a data transmission of low speed peripherals, such as a floppy drive, a serial port, and a rocker. The first connector 252 and the second connector 254 may be considered as a part of the second connection interface 115, and are mainly used to connect the microcontroller 110 and the graphic card 140. The first connector 252 may be disposed on the motherboard 200, and the second connector 254 may be disposed on the graphic card 140. The first connector 252 and the second connector 254 are connected through the GPIO interface.

The I/O chip 210 is coupled to the chipset 220 and the microcontroller 110, the I/O chip 210 and the chipset 220 may output the regulation signal (RS as shown in FIG. 1) to the graphic card 140 together, so as to correspondingly adjust the operation parameter of the graphic card 140. In other words, in this embodiment, when the motherboard 200 performs the performance mode switch, the operation parameter of the graphic card 140 may be controlled and adjusted through the microcontroller 110 and the I/O chip 210 at the same time. In addition, the microcontroller 110 may adjust the operation parameter of the graphic card 140 through the bus 125 between the chipset 220 and the graphic card 140, so as to increase the power saving and the performance improve effects. The function of the microcontroller 110 may be modified through firmware. The remaining implementation details of this embodiment may be obtained with reference to the first embodiment, and thus are not repeated here.

### Third Embodiment

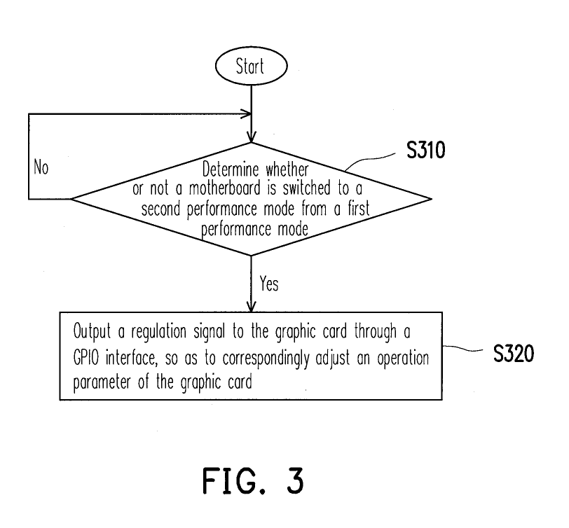

From another point of view, a power managing method for the graphic card may be concluded from the above embodiments. Referring to FIG. 3, a flow chart of a power managing method for a display according to a third embodiment of the present invention is shown. Firstly, in Step S310, it is determined whether or not a motherboard is switched to a second performance mode from a first performance mode, for example, to a low performance mode from a high performance mode, or to the high performance mode from the low performance mode. When the motherboard performs a performance mode switch, the process proceeds to Step S320, the motherboard inputs a regulation signal to the graphic card through a GPIO interface, so as to correspondingly adjust an operation parameter (for example, an operation voltage, an operation frequency etc.) of the graphic card, such that the operation performances of the motherboard and the graphic card may match with each other, thereby further improving the power saving or the performance improve effect. The remaining details of the power managing method of this embodiment may be obtained with reference to the description of the first embodiment and the second embodiment, and are not repeated here.

To sum up, in the present invention, the exclusive connection interface is disposed between the motherboard and the graphic card, such that the motherboard may dynamically adjust the operation parameter of the graphic card according to different performance modes. In this manner, the operation states of the motherboard and the graphic card may be more coordination, thus achieving better and more efficient overall power saving or performance improve effect of the computer, and more convenient power management.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A motherboard, comprising:
a first connection interface, connected to a graphic card; and
a microcontroller, connected to the graphic card through a second connection interface;
wherein when the motherboard is switched to a second performance mode from a first performance mode, the microcontroller outputs a regulation signal to the graphic card through the second connection interface, so as to adjust an operation parameter of the graphic card.

2. The motherboard according to claim 1, wherein the first performance mode is a high performance mode and the second performance mode is a low performance mode.

3. The motherboard according to claim 1, wherein the first performance mode is a low performance mode and the second performance mode is a high performance mode.

4. The motherboard according to claim 1, further comprising:
a chipset, connected to the graphic card through a system management bus;
wherein the microcontroller is connected to the chipset and outputs the regulation signal to the graphic card through the system management bus, so as to correspondingly adjust the operation parameter of the graphic card.

5. The motherboard according to claim 4, wherein the chipset comprises a Southbridge chip and a Northbridge chip, wherein the Southbridge chip is connected to the Northbridge chip and connected to the graphic card through the system management bus.

6. The motherboard according to claim 4, further comprising:
An input/output (I/O) chip, connected to the chipset and the microcontroller;
wherein the microcontroller and the I/O chip output the regulation signal to the graphic card together commonly, so as to correspondingly adjust the operation parameter of the graphic card.

7. The motherboard according to claim 1, wherein the second connection interface is a general purpose I/O (GPIO) interface.

8. The motherboard according to claim 1, wherein the second connection interface comprises:
a first connector, disposed on the motherboard; and
a second connector, disposed on the graphic card, and connected to the first connector through a GPIO interface.

9. The motherboard according to claim 1, wherein the operation parameter of the graphic card comprises an operation frequency or an operation voltage.

10. The motherboard according to claim 1, further comprising:
a button, connected to the microcontroller, for enabling the microcontroller to output the regulation signal to the graphic card, so as to adjust the operation parameter of the graphic card.

11. The motherboard according to claim 1, wherein the first connection interface comprises:
a slot, connected to the display; and
a bus, wherein the microcontroller is connected to the slot through the bus.

12. The motherboard according to claim 1, wherein the first connection interface is a peripheral component interface (PCI) or a PCI Express interface.

13. A power managing method for a graphic card, comprising:
determining whether or not a motherboard is switched to a second performance mode from a first performance mode; and
outputting a regulation signal to the graphic card through a general purpose I/O (GPIO) interface, when the motherboard is switched to the second performance mode from the first performance mode, so as to correspondingly adjust an operation parameter of the graphic card.

14. The power managing method according to claim 13, wherein the first performance mode is a high performance mode and the second performance mode is a low performance mode.

15. The power managing method according to claim 13, wherein the first performance mode is a low performance mode and the second performance mode is a high performance mode.

16. The power managing method according to claim 13, wherein the operation parameter of the graphic card comprises an operation frequency or an operation voltage.
